(19) United States
(12) Patent Application Publication
(10) Pub. No.: US 2025/0195926 A1
(43) Pub. Date: Jun. 19, 2025

(54) FLAME ARRESTOR SCREW

(71) Applicant: Woodward, Inc., Fort Collins, CO (US)

(72) Inventor: Gregory J. Brodsack, Loveland, CO (US)

(73) Assignee: Woodward, Inc., Fort Collins, CO (US)

(21) Appl. No.: 19/071,093

(22) Filed: Mar. 5, 2025

Related U.S. Application Data
(62) Division of application No. 17/493,090, filed on Oct. 4, 2021.

(51) Int. Cl. A62C 4/02; F16K 17/36; G01M 3/04

(52) U.S. Cl. CPC A62C 4/02; F16K 17/36; G01M 3/04

(57) ABSTRACT

A flame arrestor screw for a solenoid operated gas admission valve. The flame arrestor screw may include a screw body having a first end and an open end. The flame arrestor screw may include a gas passage extending from the open end along a longitudinal axis of the screw body and terminating at a terminal end within the screw body. A through hole may extend through the screw body transverse to the gas passage and in fluid communication with the gas passage.

### CROSS-REFERENCE TO RELATED PATENT APPLICATIONS

This patent application is a divisional of co-pending U.S. patent application Ser. No. 17/493,090, filed Oct. 4, 2021, the entire teachings and disclosure of which are incorporated herein by reference thereto.

### FIELD OF THE INVENTION

This invention generally relates to solenoid operated gas admission valves (SOGAV) and more particularly to a flame arrestor associated with detecting leaks around or through a sealing element for solenoid coil leads of an SOGAV.

### BACKGROUND OF THE INVENTION

SOGAVs may be electrically actuated, high response gas admission valves for in-manifold (port) fuel admission. For example, an SOGAV may be used for four-cycle, turbocharged, and natural gas or dual fuel engines. In most applications there may be an SOGAV for each cylinder. Additionally, in certain applications the SOGAV must provide a means to detect leakage around or through the hermetic sealing element for the solenoid coil leads of the SOGAV. FIG. 6 illustrates a prior art means to detect such leaks in an SOGAV 400 by including a leak detection passage 402 in the housing 304 surrounding a hermetic sealing element 406. Any leakage around or through the hermetic sealing element 306 goes through this leak detection passage 402 to a corresponding intake manifold passage to sensors which detect the presence of explosive gases.

In an effort to enhance safety for some versions of these SOGAVs 400, a means to arrest the flame front of any internally-sourced explosive event must be present within the leak detection passage 402. Past efforts having included use of a sintered-metal plug 308 mounted in the leak detection passage 402. In addition to permitting adequate venting for the purpose of detecting leaks, the sintered metal plug 408 is porous to arrest the propagation of an internal explosion and thereby contain the combustion event within the SOGAV 400. By porous it is meant that the sintered metal plug 408 is not solid but instead has a plurality of pours at its outer surface and into the body of the sintered metal plug 408 to permit a leaked gas to be received therein and to pass through and then out of the leak detection passage 402.

The sintered metal plug 408 is inserted into the leak detection passage 402 and retained with a roll pin 410. This approach uses three components, the housing 404, the sintered metal plug 408, and the roll pin 410. The use of these three parts requires a cumbersome assembly process due to the small size of the sintered metal plug 408 and the roll pin 410. Removal of the sintered metal plug 408 is not straight-forward and can result in damaged components. Moreover, maintenance of the sintered metal plug 408 is not feasible and there is no established process on how to clean dirty or clogged sintered metal plugs 408 that are porous.

In view of the above, there is a need in the art for a flame arrester that allows passage of any leaked explosive gas while preventing propagation of an internal explosion and thereby contain the combustion event within the SOGAV that may be easily installed and removed, and that does not suffer from the clogging issues apparent with sintered metal plugs. Embodiments of the present invention, as well as additional inventive features, will be apparent from the description of the invention provided herein.

### BRIEF SUMMARY OF THE INVENTION

To avoid the drawbacks of the sintered plug approach, a flame arrestor screw is provided in embodiments of this invention. The flame arrestor screw has an extended diameter that fits into a close-fitting hole in the leak detection passage. The resulting diametral clearance gap provides ample flow area to support a leak detection function. This small clearance gap also mitigates flame propagation, making this an effective flame arrestor.

Further, a through hole, that may be a cylindrical orifice, is in fluid communication with the gap. The cylindrical orifice passes completely through the flame arrestor transverse to and in fluid communication with a gas passage within the flame arrestor screw. The gas passage permits the gas to exit the flame arrestor screw for detection by a sensor. Benefits of this flame arrestor screw approach over the prior sintered metal plug include a simpler design, fewer components, easier manufacture of components, easier assembly, disassembly, cleaning, and reuse. Further benefits include the use of standard tools in assembly, disassembly, cleaning, and simplified process documentation and traceability.

In one aspect, the invention provides a flame arrestor screw for a solenoid operated gas admission valve. The flame arrestor screw includes a screw body having a first end and a first open end. A first gas passage extends from the open end along a longitudinal axis of the screw body and terminates at a terminal end within the screw body. Thus the first gas passage is entirely within the screw body. A first through hole extends through the screw body transverse to the first gas passage and in fluid communication with the gas passage.

The first through hole may be a cylindrical orifice that is an inlet into the screw body for a leaked gas. In this sense, there are two inlets on opposed sides of the screw body to permit the leaked gas to pass into the first through hole where it is channeled by cylindrical walls of the housing surrounding the through hole until the leaked gas reaches the first gas passage where it can exit the screw body from an outlet of the screw body at its open end. However, embodiments may provide a screw body having more or fewer inlets into the first gas passage.

In another aspect, the invention provides a solenoid operated gas admission valve having a sealing element in a housing. The sealing element seals solenoid coil leads from a gas in the solenoid operated gas admission valve. The solenoid operated gas admission valve includes a leak detection passage within the housing. The leak detection passage receives any gas that might be leaked around or through the sealing element. The leak detection passage receives a flame arrestor screw creating a circumferential gap between the leak detection passage and a portion of the flame arrestor to channel a leaked gas into a through hole of flame arrestor.

In yet another aspect, the invention provides a method for detecting a gas leak in a solenoid operated gas admission valve. The method includes receiving a flow of leaked gas into a leak detection passage of a housing of the solenoid operated gas admission valve. The method includes the step of passing the flow along a circumferential gap defined between a solid cylindrical wall of a flame arrestor screw and a cylindrical wall of the leak detection passage. The method includes receiving the flow into a through hole extending through the solid cylindrical wall of the flame arrestor screw. The method includes passing the flow from the through hole to a gas passage of the flame arrestor screw. The method includes passing the gas flow from gas passage to a sensor outside of the gas passage and flame arrestor screw and then sensing the flow passed to the sensor.

The aspects of the invention discussed above may include the following features alone or in combination with any number of the features discussed below.

The first end may be a closed end.

The first gas passage may be divided such that there is the first gas passage and a second gas passage. The first and second gas passages may be physically separated from one another within the screw body such that they are not in fluid communication.

The first gas passage may have a first through hole and the second gas passage may have a second through hole similar to the first through hole. In the embodiment having the first and second gas passages the first end may be a second open end to permit entry of a leaked gas into the second gas passage and to exit the second through hole outside the screw body. Thereafter, the leaked gas may enter the first through hole and then the first gas passage to exit the screw body from the first open end.

The screw body, in an embodiment has a total length measured from the open end to the first end. The distance from the first open end to a center axis of the through hole is less than half of the screw body length.

The screw body, in an embodiment has a solid cylindrical portion that extends from the first end toward the first open end. In an embodiment, the solid cylindrical portion does not include the first gas passage or the first though hole and therefore is free of the first gas passage and the first through hole. In another embodiment, the solid cylindrical portion includes either or both of the gas passage or the through hole.

The solid cylindrical portion is not porous as in the prior art sintered plug. The solid cylindrical portion does not permit gas to pass through it. The solid cylindrical portion is not threaded and therefore has a smooth outermost surface to permit the passage of a leaked gas over the outermost surface.

The solid cylindrical portion may extend between 30 and 70 percent of a screw body length, the screw body length extending from the open end to the first end is the total length of the screw body. The extension of the solid cylindrical portion, that is, the length of the solid cylindrical portion is specifically sized to arrest the flames propagating from the solenoid area resulting from a leaked gas. So too, the outermost diameter of the solid cylindrical portion is sized to cooperate with the cylindrical walls defining the leak detection passage to create the circumferential gap to arrest the flames of the exploding gas. The length of the solid cylindrical portion and the outermost diameter of the solid cylindrical portion permit the screw body of the flame arrestor screw to be removably secured in a leak detection passage of a SOGAV. For example, it could be removably secured via external threads on a head of the flame arrestor screw that are received by internal threads of the leak detection passage of the housing of a SOGAV.

The screw body in an embodiment has a first cylindrical portion of a first outermost diameter. The first cylindrical portion includes the solid cylindrical portion. The first cylindrical portion extends from the closed end toward the first open end and in an embodiment terminates at a first interface between the first portion and a second portion of the screw body. The first cylindrical portion is free of threads.

The first cylindrical portion may extend from the closed end toward the open end and terminates at a drive head. In this embodiment there is a threaded region surrounding the first cylindrical portion located between the solid portion of the first cylindrical portion and the drive head.

The first cylindrical portion pay be surrounded by a threaded region, include the second open end and include a second gas passage. The first cylindrical portion may extend from the second open end to the second cylindrical portion. The second cylindrical portion may include a second through hole in fluid communication with the second gas passage. The second cylindrical portion may include the first gas passage or at least a portion of the first passage and may include the first through hole in fluid communication with the first gas passage. However, the second gas passage and first gas passage are not in fluid communication.

The second portion of the screw body in an embodiment has a second outermost diameter that is greater than the first outermost diameter. In another embodiment the drive head has a second outermost diameter greater than the first outermost diameter.

The first interface of the screw body is a first circumferential chamfer transitioning the first outermost diameter to the second outermost diameter. The first circumferential chamfer provides a bearing surface received by a seat in the leak detection passage of the housing. The bearing surface facilitates the correct alignment, seating and fixture of the screw body when inserted in the leak detection passage.

The second portion of the screw body in an embodiment is cylindrical. The second portion extends from the first interface toward the first open end to a head portion of the screw body.

The gas passage of the screw body in an embodiment has a passage length that extends from the open end to the terminal end that may be 30 to 70 percent of a screw body length. The screw body length is the total length of the flame arrestor screw and extends from the open end to the closed end.

The gas passage of the screw body in an embodiment has a first passage cylindrical portion having a first passage innermost diameter. The first passage cylindrical portion extends from the terminal end toward the open end to a first transition area between the first passage cylindrical portion and an engagement portion within the head portion of the screw body. In another embodiment the first passage cylindrical portion of the gas passage extends from the terminal end to an engagement portion within the drive head of the screw body.

The engagement portion has an engagement inner diameter that is greater than the first passage inner diameter.

The engagement portion is shaped to cooperate with a tool inserted therein to permit clockwise and counter clockwise rotation of the head portion of the screw body, the head portion have external threads. The rotation permits tightening and loosening of the screw body when received into and removed from the leak detection passage with cooperating internal thread. Such removal for example, might be done for cleaning the flame arrestor screw or the leak detection passage in the housing. Alternatively, such removal and insertion might be to replace the flame arrestor screw with another.

The engagement portion in one embodiment has an outlet to permit passage of the leaked gas from the gas passage to a manifold passage and to sensors for detecting the leaked gas.

The solid portion of the screw body in an embodiment extends from a first end toward an open end of the screw body. The solid portion completely fills the screw body of the flame arrestor screw along the extension. The solid portion is free of the gas passage and the through hole and is not porous nor hollow.

The solid portion is between the sealing element and the open end of the screw body when inserted into a leak detection passage of a housing of a SOGAV. This arrangement facilitates the leaked gas having to pass over the surfaces of the solid portion a sufficient length so that in the event of an explosion of the gas inside the leak detection passage the flame is arrested along and not in the end face or outer cylindrical surface of the solid portion and thereby prevent a larger explosion of the gas outside the housing.

When the flame arrestor screw is fully screwed into the leak detection passage of the SOGAV housing a circumferential gap is defined between a cylindrical outermost surface of the solid portion and a cylindrical wall surface of the housing defining the leak detection passage. The circumferential gap permits the leaked gas to pass along a longitudinal extension of the solid portion into the first through hole. This permits the gas to be detected in a controlled manner as it exits the flame arrestor screw but arrests a flame produced by an explosion of the gas in the circumferential gap.

The flame arrestor screw in an embodiment is threadingly received into the leak detection passage. In another embodiment the flame arrestor screw is press fit into the leak detection passage or may be fixed therein by known means, for example, via weldment.

The leak detection passage in an embodiment has a chamfered circumferential seat that receives and seats a complimentary chamfered circumferential portion of the flame arrestor screw. The seating arrangement cooperates with the first circumferential chamfer of the screw body to facilitate the correct alignment, seating and fixture of the screw body when inserted in the leak detection passage. In another embodiment, the leak detection passage has a flat seat extending radially, that is, generally perpendicular to a longitudinal central axis of the leak detection passage. The flat seat of the leak detection passage in this embodiment is a bearing surface that receives and seats a complimentary flat surface of an embodiment of the screw body having a drive head.

A second gas passage may be separated from the first gas passage by a solid portion of the screw body such that the first and second gas passage portions are not fluidly connected.

The second gas passage may extend from the second open end to a second through hole. The second through hole may extend through the screw body transverse to the second gas passage.

A drive head at the first open end of the screw body may include an engagement portion of the first gas passage. The engagement portion includes an outlet to permit passage of a gas from the first gas passage to a manifold passage and to sensors for detecting the gas.

The second gas passage may extend longitudinally from the second open end to a second through hole. The second through hole may extend through the screw body transverse to the longitudinal extension of the second gas passage.

A threaded region may surround at least a portion of the screw body surrounding the second gas passage.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a partial cross sectional view of a solenoid operated gas admission valve with an embodiment of a flame arrestor screw according to the teachings of the invention;

FIG. 2 is an enlarged partial cross sectional view of the solenoid operated gas admission valve to better illustrate the flame arrestor screw in the leak detection passage of FIG. 1;

FIG. 3 is an enlarged cross sectional view of the flame arrestor screw of FIG. 1 rotated 90 degrees;

FIG. 4 is a partial cross sectional view of another embodiment of a solenoid operated gas admission valve with another embodiment of a flame arrestor screw according to the teachings of the invention;

FIG. 5 is an enlarged cross sectional view of another embodiment of a solenoid operated gas admission valve with another embodiment of a flame arrestor screw; and.

FIG. 6. is a partial cross sectional view of a prior art solenoid operated gas admission valve with a sintered plug.

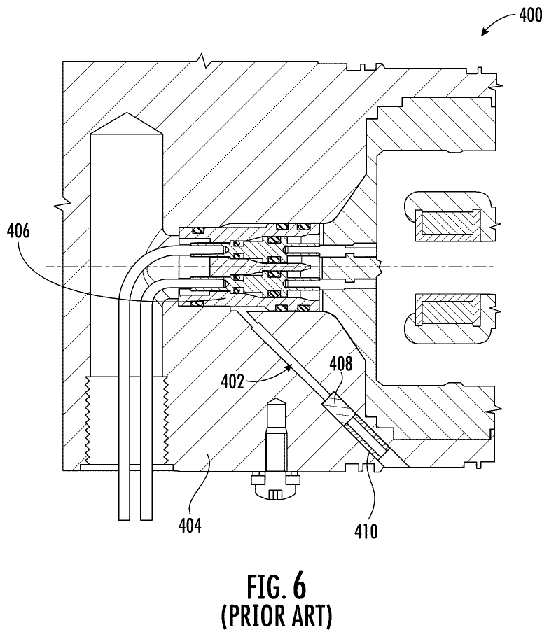

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

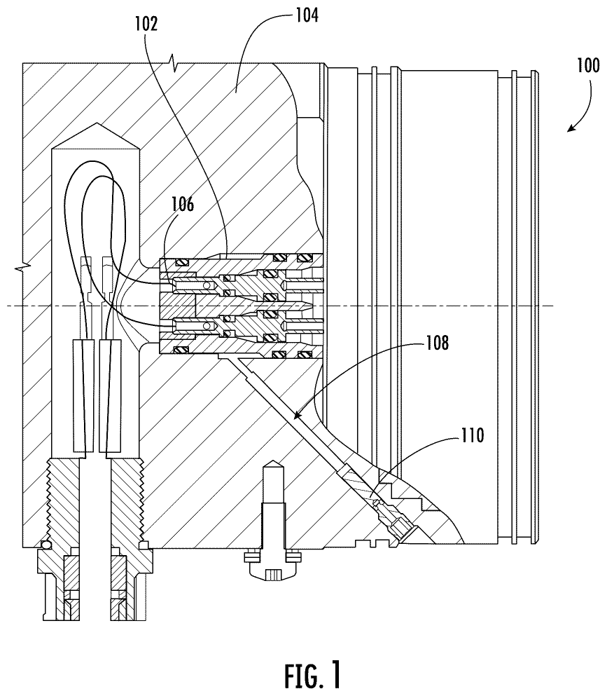

FIG. 1 illustrates a solenoid operated gas admission valve 100 having a sealing element 102 in a housing 104 sealing solenoid coil leads 106 from a gas in the solenoid operated gas admission valve 100. Should a gas leak around or through the sealing element 102 develop, the solenoid operated gas admission valve 100 includes a leak detection passage 108 within the housing 104 for receiving the gas leak around or through the sealing element 102. The leak detection passage 108 removably receives a flame arrestor screw 110 within the leak detection passage 108. The flame arrestor screw 110 is located in its entirety within the leak detection passage 108. By removably received it is meant, for example, that the flame arrestor screw 110 may be threaded to permit it to be screwed into, and for removal, out of the leak detection passage 108.

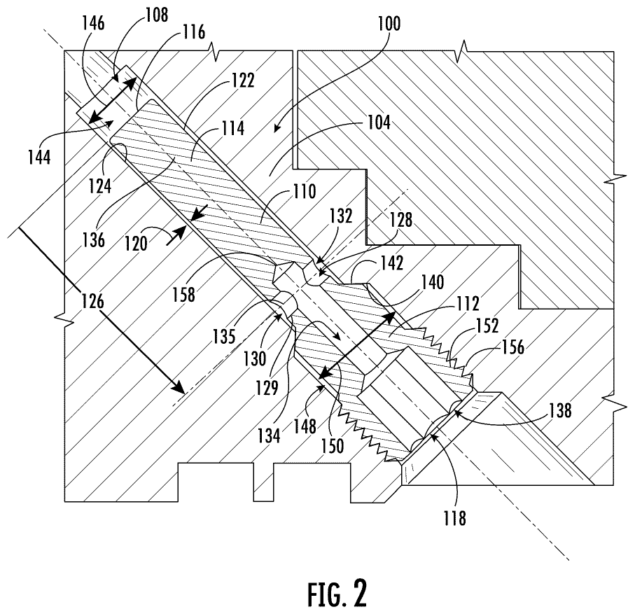

FIG. 2 illustrates in greater detail the flame arrestor screw 110 fully screwed into and fully received in the leak detection passage 108 of the solenoid operated gas admission valve 100. The flame arrestor screw 110 has a screw body 112. The screw body 112 has a solid portion 114 that is solid cylinder in longitudinal extension 126 from a closed end 116 of the screw body 112 toward an open end 118 of the screw body 112. By solid it is meant that it is not hollow nor is it porous such that gas cannot pass through the solid portion 114. The solid portion 114 completely fills the screw body 112 along the longitudinal extension 126. The solid portion 114 may be centered in the screw body 112 along a central longitudinal axis 136 of the screw body 112. Further, the solid portion 114 is between the sealing element 102 (FIG. 1) and the open end 118 of the screw body 112 when inserted into the leak detection passage 108. The solid portion 114 is free of threads. In another embodiment, the solid portion 114 need not be centered along the central longitudinal axis 136 and may be offset relative to the central axis.

A circumferential gap 120 is defined between a cylindrical outermost surface 122 of the solid portion 114 and a cylindrical wall surface 124 of the housing 104 defining the leak detection passage 108. The circumferential gap 120 surrounds the solid portion 114 of the flame arrestor screw 110. The circumferential gap 120 may be 0.210+/−0.050 millimeters. However in another embodiment, the circumferential gap may be between 0.05 and 0.1 millimeters, and in yet another embodiment may be between 0.02 and 0.06 millimeters. The circumferential gap 120 permits any leaked gas from the sealing element 102 (FIG. 1) to pass from the leak detection passage 108 in the direction of the longitudinal extension 126 defined between the cylindrical outermost surface 122 of the solid portion 114 and the cylindrical wall surface 124 of the housing 104 and into a first through hole 128 of the flame arrestor screw 110. Accordingly, the circumferential gap 120 size may be determined based upon the properties of the gas passing therethrough. Gas enters into the flame arrestor screw 110 through cylindrical orifices 130, 132 that act as inlets for gas entering the first through hole 128.

The cylindrical orifices 130, 132 are on opposite sides of the flame arrestor screw 110. However, it can be readily appreciated that in other embodiments there may be more or fewer cylindrical orifices 130, 132. A leaked gas entering the cylindrical orifices 130, 132 is channeled by a wall 129 that is cylindrical and defined by the screw body 112 so as to define the first through hole 128. From the first through hole 128 the gas passes into a first gas passage 134 inside of the flame arrestor screw 110. The first gas passage 134 extends from a terminal end 158 transversely with respect to a center axis 135 of the first through hole 128. The first gas passage 134 extends along and thus parallel to a central longitudinal axis 136 of the screw body 112. The leaked gas can then exit via an outlet 138 of the first gas passage 134 at the open end 118 of the screw body 112 and to a sensor (not illustrated) for detecting the leaked gas. The solid portion 114 in an embodiment may not include, that is, it is free of first gas passage 134 and the first through hole 128 as well as the two orifices 130,132. However, as seen in FIG. 2, the solid portion 114 include at least a portion of the first gas passage 134 and may also include all of or at least a portion of the first through hole 128.

Any flame produced by an explosion of the leaked gas within the leak detection passage 108 encounters the closed end 116 of the screw body 112 and the cylindrical wall surface 124 of the housing 104 of the leak detection passage 108. Thereafter, the flame is arrested as it passes into the circumferential gap 120 defined between a cylindrical wall surface 124 of the leak detection passage 108 and the cylindrical outermost surface 122 of the solid portion 114 along its longitudinal extension 126. It can be readily appreciated that the length, that is the longitudinal extension 126 of the solid portion 114 of the screw body 112 is sized to arrest the flame in the circumferential gap 120 and is determined based upon the properties of the gas that may pass therethrough. In an embodiment, the flame arrestor screw 110 is stainless steel and may in a preferred embodiment be stainless steel class A2-70. However, it is not the intent to limit the flame arrestor screw 110 to stainless steel, as other materials, as readily understood by those skilled in the art can readily appreciate.

Still with respect to FIG. 2, the leak detection passage 108 has a chamfered seat 140 that receives and seats a first circumferential chamfer 142 of the screw body 112. This seating arrangement facilitates correct alignment, spacing, and fixture of the screw body 112 when inserted in the leak detection passage 108. The chamfered seat 140 of the leak detection passage 108 transitions a first passage portion 144 of the leak detection passage 108 having a first passage inner diameter 146 to a second passage portion 148 having a second passage inner diameter 150. The second passage inner diameter 150 is greater than first passage inner diameter 146. The second passage portion 148 includes an internal thread portion 152 for threadingly receiving a head portion 156 of the screw body 112. The head portion 156 in an embodiment may be sized as prescribed as in an M4×0.7-6 g screw. However, it is not the intent to limit the embodiment to this size as can be readily appreciated, other sizes may be used depending on the size of the SOGAV.

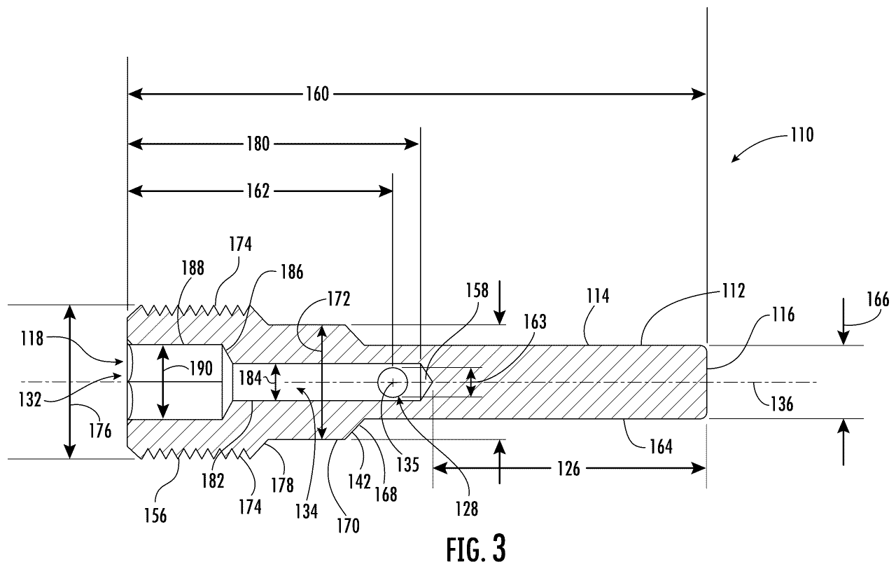

Turning now to FIG. 3, another cross section of the flame arrestor screw 110 is illustrated to show the flame arrestor screw rotated 90 degrees relative to FIG. 2. The screw body 112 of the flame arrestor screw 110 has the closed end 116 and the open end 118 previously discussed. The first gas passage 134 extends from the open end 118 centered along the central longitudinal axis 136 of the screw body 112 and terminates at the terminal end 158 within, that is, inside the screw body 112. Accordingly, the longitudinal extension 126, that is the length of the solid portion 114 of the screw body 112, extends from the closed end 116 to the terminal end 158 of the first gas passage 134.

The first through hole 128 extends at least through the exterior to the first gas passage 134, and in one embodiment through the screw body 112 transverse to the first gas passage 134 to form two orifices 130,132 (FIG. 2). The first through hole 128 is in fluid communication with the first gas passage 134 at the intersection of the first through hole 128 with the first gas passage 134. The screw body length 160 of the screw body 112 is defined between the open end 118 and the closed end 116. The distance 162 of the first gas passage 134 from the open end 118 to the center axis 135 of the first through hole 128 may be less than half of the screw body length 160. Thus, the first through hole 128 is located along the screw body 112 so as to permit a long enough extension 126 of the solid portion for arresting a leaked gas. The solid portion 114 extends between 30 and 70 percent of the screw body length 160. In a preferred embodiment it extends between 35 and 65 percent and in a preferred embodiment between 45 and 60 percent of the screw body length 160.

In an embodiment, the distance 162 of the gas passage is 7+/−0.25 mm and screw body length may be 15.25+/−0.25 mm. In an embodiment the first through hole 128 may have an inner diameter 163 between 0.6 and 0.9 mm.

Still with respect to FIG. 3, the screw body 112 has a first cylindrical portion 164 of a first outermost diameter 166. In an embodiment, the first outermost diameter 166 is 1.98+/−0.025 mm. The first cylindrical portion 164 extends from the closed end 116 toward the open end 118 and terminates at the first circumferential chamfer 142 which is a first interface 168 between the first cylindrical portion 164 and a second cylindrical portion 170 of the screw body 112. In an embodiment, the length of the extension of the first cylindrical portion 164 may be 9+/−0.25 mm. The first circumferential chamfer 142 may be between 30 and 60 degrees. In a preferred embodiment it may be between 40 and 50 degrees and in a more preferred embodiment between 44 and 46 degrees. The second cylindrical portion 170 has a second outermost diameter 172 that is greater than the first outermost diameter 166. The first circumferential chamfer 142 transitions the first outermost diameter 166 to the second outermost diameter 172. In an embodiment, the second outermost diameter 172 may be 3+/−0.125 mm.

The second cylindrical portion 170 extends from the first interface 168 toward the open end 118 to the head portion 156. In an embodiment, the total distance between the start of the first circumferential chamfer 142 and the start of the head portion 156 may be 2.50+/−0.125 mm. The head portion 156 is circumscribed with threads 174 providing a third outermost diameter 176 that, in an embodiment may be 4+/−0.125 mm. The threads 174 are external threads that circumscribe the head portion 156 to permit the screw body 112 to be removably secured inside the leak detection passage 108 (FIG. 1). In in embodiment, the head portion with threads 174 may have a length of 3.75+/−0.125 mm.

The first gas passage 134 has a passage length 180 that is its total length that extends from the open end 118 to the terminal end 158 that is 30 to 70 percent of a screw body length 160. In another embodiment it is 35 to 65 percent of the screw body length 160, and in a preferred embodiment it is 40 to 60 percent of the screw body length 160. In an embodiment the passage length 180 is 7.75+/−0.25 mm. The first gas passage 134 has a first passage cylindrical portion 182 that has a first passage inner diameter 184. The first passage inner diameter may be 1+/−0.125 mm. The first passage cylindrical portion 182 extends from the terminal end 158 toward the open end 118 to a first transition area 186 between the first passage cylindrical portion 182 and an engagement portion 188.

The engagement portion 188 has an engagement inner diameter 190 that is greater than the first passage inner diameter 184. The engagement portion 188 is shaped to cooperate with a tool inserted therein to permit clockwise and counter clockwise rotation of the screw body 112 to permit tightening and loosening of the screw body 112 when received into the leak detection passage 108 (FIG. 2). The engagement portion 188 may be shaped to cooperate, for example, with an Allen wrench also known as hex wrench or a torx wrench by way of non-limiting examples. The engagement portion 188 permits the passage of a leaked gas from the outlet 138 of first gas passage 134 to a manifold passage (not illustrated) and to sensors (not illustrated) for detecting the leaked gas.

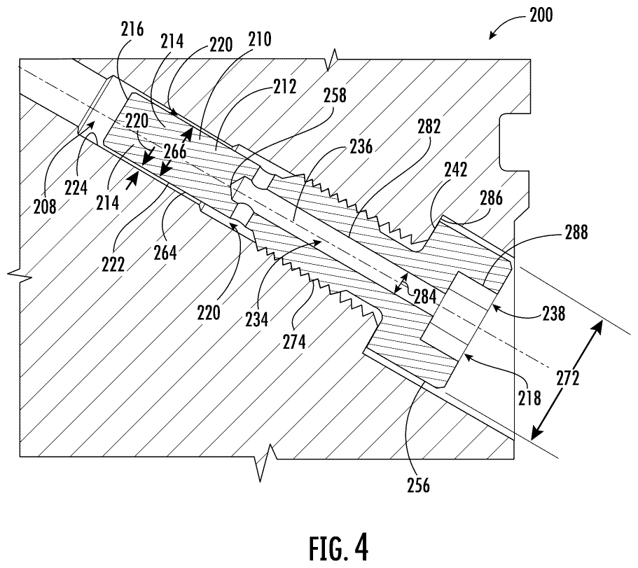

Turning to FIG. 4, a cross section as in FIG. 2 of another embodiment of solenoid operated gas admission valve 200 of a flame arrestor screw 210 is illustrated. The flame arrestor screw 210 is the same as the flame arrestor screw 110 (FIG. 2) except for differences which will be discussed herein. So too, a leak detection passage 208 and a first gas passage 234 are the same as the leak detection passage 108 (FIG. 1) and the first gas passage 134 (FIG. 1) except for the differences to be discussed herein.

The flame arrestor screw 210 has a screw body 212. The screw body 212 has a first cylindrical portion 264 of a first outermost diameter 266. The first cylindrical portion 264 includes a solid cylindrical portion 214. The first cylindrical portion 264 extends from a closed end 216 of the screw body 212 toward a first open end 218 of the screw body 212 and terminates at a drive head 256. A threaded region 274 surrounding the first cylindrical portion 264 is located between the solid cylindrical portion 214 of the first cylindrical portion 264 and the drive head 256. The drive head 256 has a second outermost diameter 272 greater than the first outermost diameter 266. The drive head 256 includes an engagement portion 288 of a gas passage 234.

The gas passage 234 has a first passage cylindrical portion 282 having a first passage innermost diameter 284. The first passage cylindrical portion 282 extends from the terminal end 258 of the gas passage 234 to the engagement portion 288. The engagement portion 288 includes an outlet 238 so that a leaked gas may exit out of the screw body 212.

In this embodiment, a leaked gas passes from the leak detection passage 208 into a circumferential gap 220 between a cylindrical outermost surface 222 of the solid portion 214 of the screw body 212 and a cylindrical wall surface 224 of the leak detection passage surrounding the solid portion 214. The leaked gas then passes into the first through hole 228 and then into the first gas passage 234. The leaked gas then exits the screw body 212 via the outlet 238.

The leak detection passage 208 has a flat bearing surface 286 that extends radially, that is, generally perpendicular to a central longitudinal axis 236 of the screw body 212 for seating a complimentary flat surface 242 of the drive head 256 of the flame arrestor screw 210. By generally perpendicular it is meant plus or minus five degrees of perpendicular.

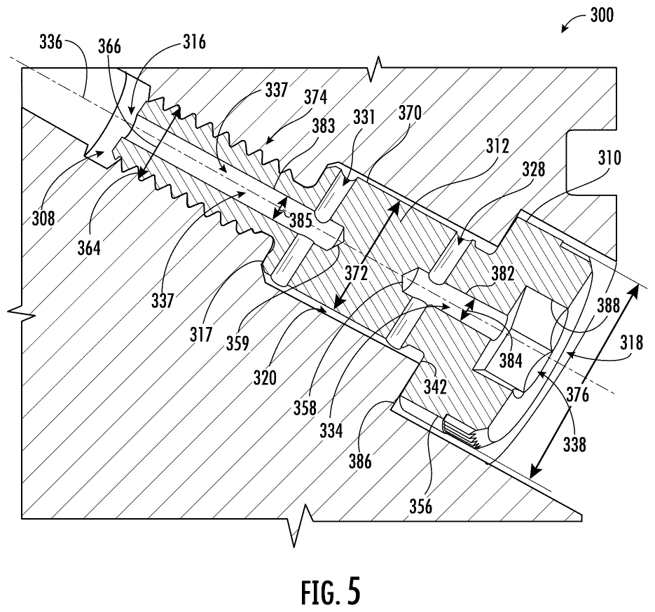

FIG. 5 illustrates a cross section, as in FIG. 4, of another embodiment of a solenoid operated gas admission valve 300 of a flame arrestor screw 310. The flame arrestor screw 310 is the same as the flame arrestor screw 210 (FIG. 4) except for differences which will be discussed herein.

The flame arrestor screw 310 has a screw body 312 extending between a first open end 318 and a second open end 316. The screw body 312 has a first cylindrical portion 364 of a first outermost diameter 366. The first cylindrical portion 364 includes a second gas passage 337. The first cylindrical portion 364 extends from the second open end 316 of the screw body 312 toward the first open end 318 of the screw body 312 and terminates at a second cylindrical portion 370. A threaded region 374 surrounding the first cylindrical portion 364 begins at the second open end 316 and terminates at the second cylindrical portion 370.

The second cylindrical portion 370 extends from an end 317 of the first cylindrical portion 364 to a drive head 356. The second cylindrical portion 370 has a second outermost diameter 372 that is greater than the first outermost diameter 372. The drive head 356 has a third outermost diameter 376 that is greater than the second outermost diameter 372. The drive head 356 includes an engagement portion 388 of a first gas passage 334.

The second gas passage 337 has a second passage cylindrical portion 383 having a second passage innermost diameter 385. The second gas passage cylindrical portion 383 extends from the second open end 316 of the second gas passage 337 to a second terminal end 359 inside the second cylindrical portion 370. A second through hole 331 extends transversely through the second cylindrical portion 370 and the second gas passage 337 such that the second gas passage 337 and the second through hole 331 are in fluid communication.

A first gas passage 334 extends from the first open end 318 to a first terminal end 358 of the first gas passage 334. The first gas passage 334 has a first passage cylindrical portion 382 having a first passage innermost diameter 384. In the illustrated embodiment the first passage innermost diameter 384 is the same as the second gas passage innermost diameter 385. The first passage cylindrical portion 382 extends from the terminal end 358 of the first gas passage 334 to the engagement portion 388. The engagement portion 388 includes an outlet 338 so that a leaked gas may exit out of the first gas passage 334 and out of the screw body 312.

As illustrated, the first gas passage 334 and the second gas passage 337 are not connected. A leaked gas passes from the leak detection passage 308 into the second gas passage 337 at the second open end 316 of the screw body 312. The leaked gas exits the second gas passage and exits the screw body through the second through hole 331. The leaked gas then passes through a circumferential gap 320 created between the cylindrical outermost surface 322 of the second cylindrical portion 370 and a cylindrical wall surface 324 of a leak detection passage 308 surrounding the second cylindrical portion 370. From the circumferential gap 320 the leaked gas passes into the first through hole 328 and into the first gas passage 334 where it exits the screw body at the first open end 318 via the outlet 338.

The leak detection passage 308 has a flat bearing surface 386 that extends radially, that is, generally perpendicular to a central longitudinal axis 336 of the screw body 312 for seating a complimentary flat surface 342 of the drive head 356.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-23. (canceled)

24. A solenoid operated gas admission valve (SOGAV) having a sealing element in a housing sealing solenoid coil leads from a gas in the SOGAV, comprising:
a leak detection passage within the housing receiving a gas leak around or through the sealing element;
a flame arrestor screw;
wherein the leak detection passage receives the flame arrestor screw creating a circumferential gap between the leak detection passage and a portion of the flame arrestor screw to channel the gas into a through hole of flame arrestor.

25. The SOGAV of claim 24, wherein the circumferential gap is defined between a cylindrical outermost surface of a solid portion of the flame arrestor screw and a cylindrical wall surface of the housing defining the leak detection passage, the circumferential gap permitting the gas to pass along a longitudinal extension of the solid portion into the through hole.

26. The SOGAV of claim 24, wherein the flame arrestor screw is threadingly received into the leak detection passage.

27. (canceled)

28. The SOGAV of claim 24, wherein the flame arrestor screw comprises:
a screw body having a first end and an open end;
a first gas passage extending from the open end along a longitudinal axis of the screw body and terminating at a terminal end within the screw body;
the through hole extending through the screw body transverse to the first gas passage and in fluid communication with the first gas passage.

29. The SOGAV of claim 28, wherein the screw body has a screw body length extending from the open end to the first end, a distance from the open end to a center axis of the through hole being less than half of the screw body length.

30. SOGAV of claim 28, wherein the screw body includes a solid cylindrical portion that extends from the first end toward the open end to the first gas passage.

31. The SOGAV of claim 30, wherein the solid cylindrical portion extending between 30 and 70 percent of a screw body length, the screw body length extending from the open end to the first end.

32. The SOGAV of claim 30, wherein the screw body has a first cylindrical portion that includes the solid cylindrical portion, wherein the first cylindrical portion and the solid cylindrical portion have a first outermost diameter, and wherein the first cylindrical portion extends from the first end toward the open end and terminates at a first interface between the first portion and a second portion of the screw body.

33. The SOGAV of claim 32, wherein the second portion of the screw body has a second outermost diameter that is greater than the first outermost diameter.

34. The SOGAV of claim 32, wherein the first interface is a first circumferential chamfer transitioning the first outermost diameter to the second outermost diameter.

35. The SOGAV of claim 32, wherein the second portion extends from the first interface toward the open end to a head portion circumscribed by threads.

36. The SOGAV of claim 28, wherein the gas passage has a passage length extending from the open end to the terminal end that is 30 to 70 percent of a screw body length extending from the open end to the first end.

37. The SOGAV of claim 28, wherein the first gas passage has a first passage cylindrical portion having a first passage inner diameter, wherein the first passage cylindrical portion extends from the terminal end toward the open end to a first transition area between the first passage cylindrical portion and an engagement portion.

38. The SOGAV of claim 37, wherein the engagement portion has an engagement inner diameter that is greater than the first passage inner diameter.

39. The SOGAV of claim 38, wherein the engagement portion is shaped to cooperate with a tool that may be inserted therein to permit clockwise and counter clockwise rotation of the screw body to permit tightening and loosening of the screw body when received into a threaded gas passage.

40. The SOGAV of claim 37, wherein the engagement portion has an outlet to permit passage of a gas from the gas passage to a manifold passage and to sensors for detecting the gas.

41. The SOGAV of claim 30, wherein the screw body has a first cylindrical portion that includes the solid cylindrical portion, wherein the first cylindrical portion and the solid cylindrical portion have a first outermost diameter, and wherein the first cylindrical portion extends from the first end toward the open end and terminates at drive head.

42. The SOGAV of claim 41, wherein the first cylindrical portion has a threaded region between the solid cylindrical portion and the drive head, and the drive head is free of threads.

43. The SOGAV of claim 41, wherein the drive head has a second outermost diameter greater than the first outermost diameter.

44. The SOGAV of claim 41, wherein the drive head includes an engagement portion of the gas passage, the engagement portion including an outlet to permit passage of the gas from the first gas passage to a manifold passage and to sensors for detecting the gas.

45. The SOGAV of claim 28, wherein the first end is a closed end.

46. The SOGAV of claim 28, wherein the first end is a second open end.

47. The SOGAV of claim 46, wherein a second gas passage within the screw body is separated from the first gas passage within the screw body by a solid portion of the screw body such that the first and second gas passage portions are not fluidly connected.

48. The SOGAV of claim 47, wherein the second gas passage extends longitudinally from the second open end to a second through hole, the second through hole extending through the screw body transverse to the longitudinal extension of the second gas passage.

49. The SOGAV of claim 48, wherein a drive head at the open end of the screw body includes an engagement portion of the first gas passage, the engagement portion including an outlet to permit passage of the gas from the first gas passage to a manifold passage and to sensors for detecting the gas.

50. The SOGAV of claim 47, wherein a threaded region surrounds at least a portion of the screw body surrounding the second gas passage.

51. A method for detecting the gas leak in the SOGAV of claim 24, comprising the steps of:
receiving a flow of the leaked gas into the leak detection passage of the housing of the SOGAV;
passing the flow along the circumferential gap defined between the portion that is a solid cylindrical wall of the flame arrestor screw and a cylindrical wall of the leak detection passage, the circumferential gap having a length configured to arrest a flame that may result from an explosion of the gas within the housing;
receiving the flow into the through hole extending through the solid cylindrical wall of the flame arrestor screw;
passing the flow from the through hole to a gas passage of the flame arrestor screw;
passing the flow from the gas passage to a sensor outside of the flame arrestor screw;
sensing the flow passed to the sensor.
